(19) United States
(12) Patent Application Publication
(10) Pub. No.: US 2025/0353687 A1
(43) Pub. Date: Nov. 20, 2025

(54) Divert Merge Apparatus and Method

(71) Applicant: Aegis Sortation, LLC, Louisville, KY (US)

(72) Inventors: Dean TERRELL, Louisville, KY (US); Ken ICE, Louisville, KY (US); Cameron HICKS, Louisville, KY (US)

(73) Assignee: Aegis Sortation, LLC, Louisville, KY (US)

(21) Appl. No.: 19/067,537

(22) Filed: Feb. 28, 2025

Related U.S. Application Data
(60) Provisional application No. 63/559,148, filed on Feb. 28, 2024.

(51) Int. Cl. B65G 13/10; B65G 47/54

(52) U.S. Cl. CPC B65G 13/10; B65G 47/54

(57) ABSTRACT

Described herein are an automated roller module, a sortation system including the module, and methods of controlling the module and system. The module includes multiple pucks each including a roller whose rotation about a driving axis within an upper plane and rotation about a swivel axis normal to the upper plane are each independently and dynamically controllable. The module is thereby configured to dynamically create and control various conveyance vector fields formed by the plurality of rollers. The system is thereby configured to dynamically control items in a conveyance flow; and the method may include, but is not limited to: shifting bulk flow items into a single flow, diverting item(s) in a new direction, directing item(s) into and/or out of a flow, changing the position, orientation, and/or spacing of item(s), separating one flow of items into multiple flows, and merging items from multiple flows into a single flow.

### CROSS-REFERENCE TO RELATED APPLICATIONS

This application claims priority to prior U.S. Provisional Patent Application No. 63/559,148, filed Feb. 28, 2024, the entire disclosure of which and all attachments thereto is incorporated herein by reference in their entireties.

### BACKGROUND

### 1. Field

Example embodiments described herein relate to the field of conveyors and conveyor operation, and more particularly sortation conveyor systems in which the conveyance of packages and other goods can be directed. One or more example embodiments described herein may provide systems, devices and methods allowing conveyance of packages and other goods to be directed individually or in groups for further processing, conveying, and/or tracking.

### 2. Background

Sortation is the process of identifying packages and other goods on a conveyor system and diverting them to a specific destination. Sortation in the order fulfillment, warehousing, materials handling, and ecommerce industries has come a long way from a time when industries had few options outside of manual sorting. Today, there are a multitude of automated solutions that can boost efficiency and accuracy and reduce costs. Sortation equipment includes various types of sorters and conveyors including, but not limited to belt sorters, pop-up wheel/roller/belt sorters, pusher sorters, paddle sorters, tilt tray sorters, narrow belt sorters, and sliding shoe sorters.

Some related art sortation systems implement rollers that can be positioned along a path and can be controlled to convey or change the path of an item. Such devices are described, for example in U.S. Pat. Nos. 5,921,374; 2,874,818; and 2,613,790, the disclosures of which are incorporated herein by reference in their entireties.

### SUMMARY

Example embodiments may address at least the above such drawbacks and/or disadvantages and other disadvantages not described above. Also example embodiments are not required to overcome the disadvantages described above, and may not overcome any of the problems described above.

According to an implementation of an example embodiment, an automated roller module may comprise: a module frame; and an array of a plurality of pucks attached to the module frame, each of the plurality of pucks comprising: a support frame, a roller/driving motor combination comprising a convey roller rotatably connected to the support frame and rotatable about a driving axis parallel to an upper plane, and a driving motor connected to the support frame and operatively connected to the convey roller and configured to drive rotation of the convey roller, and a swivel motor connected to the module frame and rotatably connected to the support frame and configured to drive a rotation of the support frame with respect to the module frame about a swivel axis normal to the upper plane.

According to an example implementation, the module may further comprise: a controller operatively and independently coupled to the driving motor of each of the plurality of pucks and operatively and independently coupled to the swivel motor of each of the plurality of pucks; wherein the controller comprises a memory storing instructions and a processor configured to execute the instructions and thereby independently control a rotational speed and a direction of the convey roller of each of the plurality of pucks about the driving axis and independently control a rotation of the convey roller of each of the plurality of pucks about the corresponding swivel axis.

According to an example implementation, the control module may be configured to dynamically control the swivel motors of the plurality of pucks to form at least a first conveyance vector field and a second conveyance vector field different from the first conveyance vector field.

According to an example implementation, the module frame may comprise a top plate; wherein each of the plurality of pucks may be attached to the module frame such that the convey roller of each of the plurality of pucks protrudes above the top plate and extends below the top plate, such that the rotation of the support frame with respect to the module frame comprises rotation of the convey roller with respect to the top plate about the swivel axis

According to an implementation of an example embodiment, a sortation system may comprise: at least one automated roller module comprising: a module frame; and an array of a plurality of pucks attached to the module frame, each of the plurality of pucks comprising: a support frame a roller/driving motor combination comprising a convey roller rotatably connected to the support frame and rotatable about a driving axis parallel to an upper plane, and a driving motor connected to the support frame and operatively connected to the convey roller and configured to drive rotation of the convey roller, and a swivel motor connected to the module frame and rotatably connected to the support frame and configured to drive a rotation of the support frame with respect to the module frame about a swivel axis normal to the upper plane; and a control module operatively and independently coupled to the driving motor of each of the plurality of pucks and operatively and independently coupled to the swivel motor of each of the plurality of pucks.

According to an example implementation, the system may further comprise: an input conveyor element disposed adjacent to the at least one automated roller module; and an output conveyor element disposed adjacent to the at least one automated roller module; wherein the control module is operatively coupled to each of the input conveyor element and the output conveyor element and is configured to drive the input conveyor element to direct one or more items onto the at least one automated roller module.

According to an example implementation, the control module may comprise a memory storing instructions and a processor configured to execute the instructions and thereby independently control a rotational speed and a direction of the convey roller of each of the plurality of pucks about the driving axis and independently control a rotation of the convey roller of each of the plurality of pucks about the corresponding swivel axis.

According to an example implementation, the control module may be configured to dynamically control the swivel motors of the plurality of pucks to form at least a first conveyance vector field and a second conveyance vector field different from the first conveyance vector field.

According to an example implementation, the system may further comprise: a monitor system communicatively coupled to the control module, the monitor system comprising at least one sensing element positioned and configured to obtain data of one or more items in the sortation system and transmit the data to the control module; wherein the processor of the control module is further configured to control the driving motor and the swivel motor of each of the plurality of pucks based on the data from the monitor system.

According to an example implementation, the at least one automated roller module may comprise an array of plurality of automated roller modules.

According to an example implementation, the output conveyor element may comprise a first output conveyor element and a second output conveyor element; and the control module may be configured to dynamically control the swivel motors of the plurality of pucks to form a dynamic conveyance vector field such that at least a first item of the one or more items is conveyed onto the first output conveyor element and at least a second item of the one or more items is diverted onto the second output conveyor element.

According to an example implementation, the convey roller and the driving motor of the roller/driving motor combination may be integrally formed.

According to an implementation of an example embodiment, an automated sortation method of a sortation system may comprise a plurality of conveyor elements, at least one automated roller module comprising an array of a plurality of pucks, each of the plurality of pucks comprising a convey roller rotatable about a driving axis in an upper plane and a swivel motor configured to rotate the driven motor in the upper plane about a swivel axis normal to the upper plane; the method may comprise: controlling an input conveyor element of the plurality of conveyor elements to thereby deposit one or more items onto the automated roller module; controlling the automated roller module to form a first conveyance vector field by: independently driving the convey roller of each of the plurality of pucks, and independently driving the swivel motor of each of the plurality of pucks; and controlling the automated roller module to form a second conveyance vector field, different from the first conveyance vector field by: independently driving the convey roller of each of the plurality of pucks, and independently driving the swivel motor of each of the plurality of pucks.

According to an example implementation, the method may further comprise: at least one sensing element of the sortation system obtaining data of the one or more items; and performing the controlling the automated roller module to form a first conveyance vector field and the controlling the automated roller module to form a second conveyance vector field based on the data of the one or more items.

According to an example implementation, the controlling the automated roller module to form a first conveyance vector field and the controlling the automated roller module to form a second conveyance vector field may comprise controlling the automated roller module to form a dynamically changing conveyance vector field, thereby shifting a plurality of items from a non-organized flow into a single flow of the plurality of items and outputting the plurality of items onto at least one output conveyor element of the plurality of conveyor elements.

According to an example implementation, the one or more items may comprise a plurality of items; and the controlling the automated roller module to form a first conveyance vector field and the controlling the automated roller module to form a second conveyance vector field may comprise controlling the automated roller module to form a dynamically changing conveyance vector field, thereby changing a spacing among one or more of the plurality of items.

According to an example implementation, the one or more items may comprise a plurality of items; and the controlling the automated roller module to form a first conveyance vector field and the controlling the automated roller module to form a second conveyance vector field may comprise controlling the automated roller module to form a dynamically changing conveyance vector field, thereby performing at least one of: diverting an item of the plurality of items out of a flow of items, introducing an item of the plurality of items into a flow of items, changing an order of the plurality of items, and changing a position of at least one first item relative to a position of at least one second item, rotating at least one item.

According to an example implementation, the one or more items may comprise a plurality of items; the plurality of conveyor elements may further comprise a first output conveyor element and a second output conveyor element; and the controlling the automated roller module to form a first conveyance vector field and the controlling the automated roller module to form a second conveyance vector field may comprise controlling the automated roller module to form a dynamically changing conveyance vector field, thereby: directing a first item of the plurality of items onto the first output conveyor element and directing a second item of the plurality of items onto the second output conveyor element.

According to an example implementation, the input conveyor element may comprise a first input conveyor element and a second input conveyor element; the one or more items may comprise a plurality of items; and the controlling the automated roller module to form a first conveyance vector field and the controlling the automated roller module to form a second conveyance vector field may comprise controlling the automated roller module to form a dynamically changing conveyance vector field, thereby: merging at least one item of the plurality of items conveyed by the first input conveyor and at least one item of the plurality of items conveyed by the second input conveyor into a single flow of a plurality of items and outputting the single flow of the plurality of items onto an output conveyor element.

According to an example implementation, the at least one automated roller module may comprise an array of a plurality of automated roller modules; and the controlling the automated roller module to form a first conveyance vector field and the controlling the automated roller module to form a second conveyance vector field may comprise independently driving the convey roller of each or the plurality of pucks of each of the plurality of automated roller modules and independently driving the swivel motor of each of the plurality of pucks of each of the plurality of automated roller modules

### BRIEF DESCRIPTION OF THE DRAWINGS

The above and other objects, advantages, and salient features will become apparent to those skilled in the art from the following detailed description of example embodiments when taken in conjunction with the accompanying drawings in which:

FIG. 1 is a perspective illustration of a puck including a belt drive according to an example embodiment;

FIGS. 2A and 2B are a perspective illustration and a top view, respectively, of a puck including a poly drive according to an example embodiment;

FIG. 3A is a perspective illustration of an example puck including a swivel drive according to an example embodiment;

FIG. 3B is a perspective illustration of another example puck including a swivel drive according to an example embodiment;

FIGS. 4A and 4B illustrate different arrangements of a plurality of pucks according to example embodiments;

FIG. 5 is a perspective view of an addressable roller module XX according to an example embodiment;

FIG. 6A is a diagram of a conveyance vector field formed by an addressable roller module according to one or more example embodiments;

FIGS. 6B-6I are schematic diagrams of example vector fields formed by an addressable roller module according to one or more example embodiments;

FIG. 7 is a diagram of a sortation system including an addressable roller module according to an example embodiment;

FIGS. 8A-8C are perspective illustrations of different arrangements of multiple addressable roller modules according to one or more example embodiments; and

FIG. 9 is a flow diagram of example methods according to one or more example embodiments.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” and/or other, may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Expressions of relational orientation, such as “upper,” “lower,” “inside,” “outside,” and/or other expressions, which are used for explaining the structural positions of various components as described herein, are not absolute but relative. The orientation expressions are appropriate when the various components are arranged as shown in the figures, but should change accordingly when the positions of the various components in the figures change.

Various terms and expressions, such as, but not limited to: “module,” poly,” “swivel,” “roller,” “puck,” belt,” “diverter,” “sorter,” “park and go,” are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

One or more example embodiments described herein may improve upon various capabilities of related art sorting and discharging systems and methodologies, for example and without limitation, by providing individual features and methodologies, and various combinations thereof, that can facilitate improved flexibility and control for directing conveyance of packages/items/goods.

One or more example embodiments described herein may provide system and method for automated sortation, conveying, and/or diverting that can accumulate a set number of packages and then transfer the accumulated set number of packages for further processing and/or conveying.

One or more example embodiments described herein may provide a conveyance system comprising a plurality of proximately positioned conveying components that can be individually controlled to facilitate more precise conveyance of various size packages/items/goods in one or more desired directions, and in example implementations, at one or more desired speeds.

One or more example embodiments described herein may provide a conveyance system and methodology including, for example and without limitation, a plurality of conveying components each containing a motor allowing for computerized individual control of conveyance speed for each conveying component. Each such conveying component may be descriptively called, without implying any limitations, a “puck.” In an example implementation, each puck can contain one or more active rollers configured to selectively contact one or more packages/items/goods to be conveyed and, for example, a Motor Driven Live Roller (MDR) motor to drive at least one or more of the active rollers.

One or more example embodiments described herein may provide individual rotation for each puck where, for example, each puck can contain a rotational motor to manipulate the direction of conveyance, or flow, of packages/items/goods allowing for individual rotational control of each puck and also selective grouped control of the pucks depending on preferred flexibility for controlling flow of packages/items/goods (for example: fine control for singulation of packages/items/goods).

One or more example embodiments described herein may provide systems and methodologies that facilitate packages/items/goods tracking throughout system by configuring sensors (for example, photoelectronics) to track the leading and trailing edge of individual packages/items/goods coming in contact with conveying components, for example to ensure proper diverting.

One or more example embodiments described herein may provide systems and methodologies comprising packages/items/goods singulation and/or gapping prior to diverting of packages/items/goods, wherein packages/items/goods can proceed to conveying components for example in a single file line, with a gap therebetween, for example to further ensures proper diverting of packages/items/goods.

One or more example embodiments described herein may provide systems and methodologies comprising sensors at each divert location to confirm successful diverting or packages/items/goods.

One or more example embodiments described herein may provide systems and methodologies comprising one or more conveying components configured to convey packages/items/good in any direction, wherein modules, such as pucks, can rotate clockwise or counterclockwise up to 90 degrees whereby modules can convey packages/items/goods in either direction, which can facilitate conveyance opportunity in a full 360 range.

One or more example embodiments described herein may provide systems and methodologies that can function as a reversible system, where, for example and without limitation: in one operation, the system can be used to divert packages off of a main conveyor onto one or more exit conveyors; and in another operation, the system can receive packages from one or more exit conveyors and transport them to a main conveyor whereby the system can merge packages/items/goods into the system dynamically.

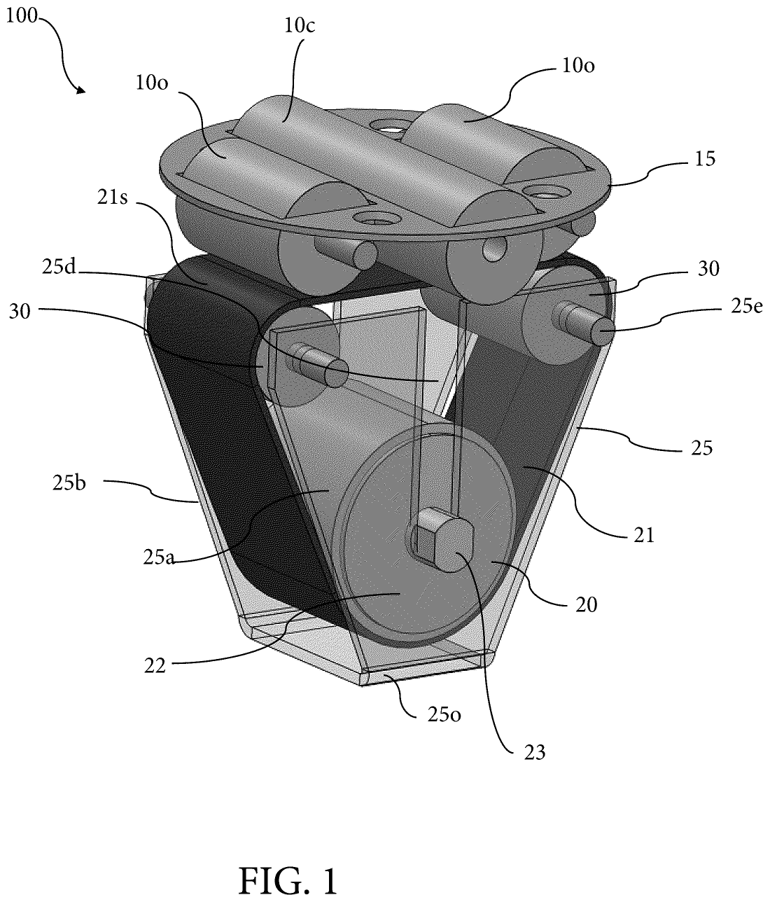

### Puck—Example Embodiment FIG. 1

FIG. 1 is a perspective illustration of a puck including a belt drive according to an example embodiment. The puck 100 includes a plate 15 supporting a plurality of convey rollers 10, and a frame 25 supporting a driving motor 20. A belt 21, driven by the driving motor 20 drives the convey rollers 10. The frame 25 supports the driving motor 20 which may be embodied as a roller 22 on an axle 23. As shown in the example embodiment of FIG. 1, the frame comprises substantially parallel sides 25a, 25b, and a base 25c. The axle 23 of the driving motor is supported between the sides 25a, 25b of the frame 25 and may be fixed to the sides 25a, 25b, and the roller 22 may rotate with respect to its axle 23. Alternately, the axle 23 may be rotatably supported by the frame 25. For example, the axle 23 may be rotatably supported in corresponding holes, slots 25d, or divots in the opposite sides 25a, 25b of the frame 25, as shown in FIG. 1. Two or more additional rollers 30 may also be supported by the frame, positioned above the driving motor 20. The additional rollers 30 may be free to rotate as driven by the belt 21, secured therearound and driven by the driving motor 20. The axles of the additional rollers 30 may be fixed between the sides 25a, 25b of the frame 25 while the additional rollers 30 rotate with respect to their axles, or the axles may be rotatably supported by the frame 25, as, for example, within corresponding slots, holes 25e, or divots in the sides 25a, 25b of the frame 25. The belt 21 is secured around the rollers 30, forming a surface 21s configured to contact and drive the convey rollers 10. Any one or more of the rollers described herein may be substantially cylindrical, as shown, or may be rollers or any other type of wheel as would be understood by one of skill in the art. The drive motor 20 may comprise a 24 Volt (V) direct current (DC) motor, or another motor as would be understood by one of skill in the art.

According to example implementations of one or more example embodiments described herein, a plate 15 can be configured to support the axles of each of a plurality of convey rollers 10 and may have a substantially circular outer circumference, as shown. As shown in FIG. 1, the plate 15 may support the axles of a central convey roller 251c and a pair of outer convey rollers 21o. The axles may be supported by means of bolts extending downward from the plate 15 at the ends of each of the axles or by another mechanical connection. The axles of the convey rollers may be fixed to the plate 15, and the convey rollers 10 may rotate with respect to their respective axles, or, the axles may be rotatably supported by the plate 15. As shown in FIG. 1, the central convey roller 10c may be longer than each of the outer convey rollers 10o, which may be of equal length, but this is merely an example, and the respective numbers, lengths, and sizes of the convey rollers may vary for this example as would be understood by one of skill in the art. The plate 15 is secured to the frame 25 such that the belt 21 is held against the undersides of the convey rollers 10. Any one or more of the rollers described herein may be substantially cylindrical, as shown, or may be rollers or any other type of wheel as would be understood by one of skill in the art.

The drive motor may be operationally coupled, via a wired or wireless connection, to a controller thus enabling the direction, speed (rotations per minute (rpm)), and power of the motor to be independently controlled, thereby enabling each of the speed, direction, and power of the one or more convey rollers of the puck to be independently controlled.

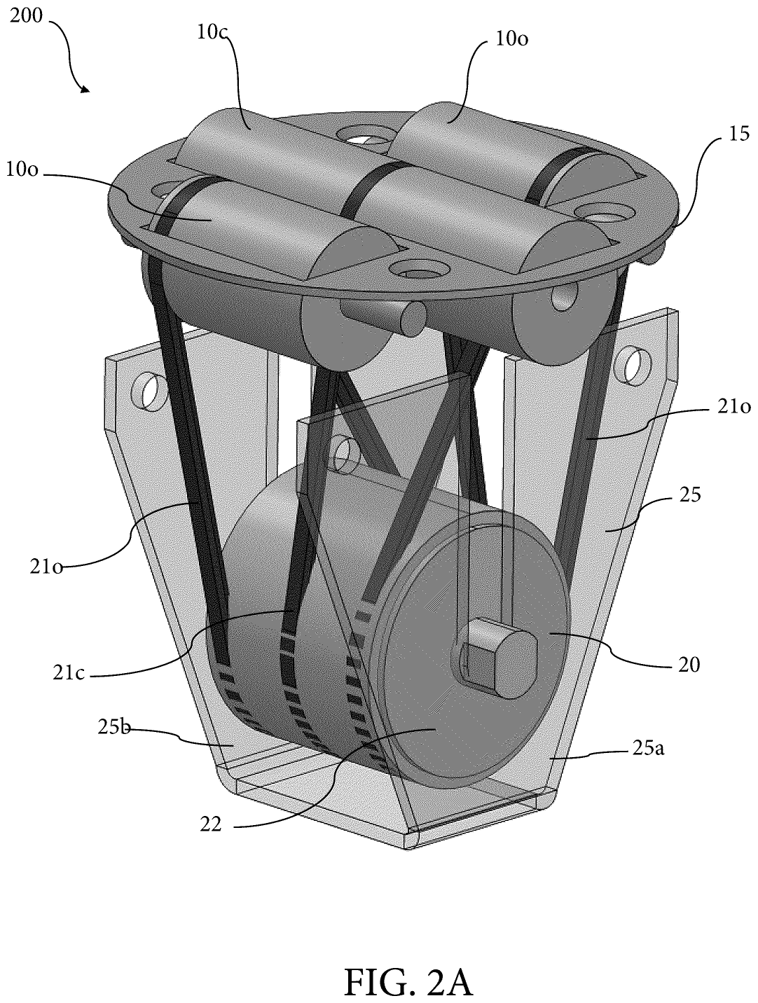

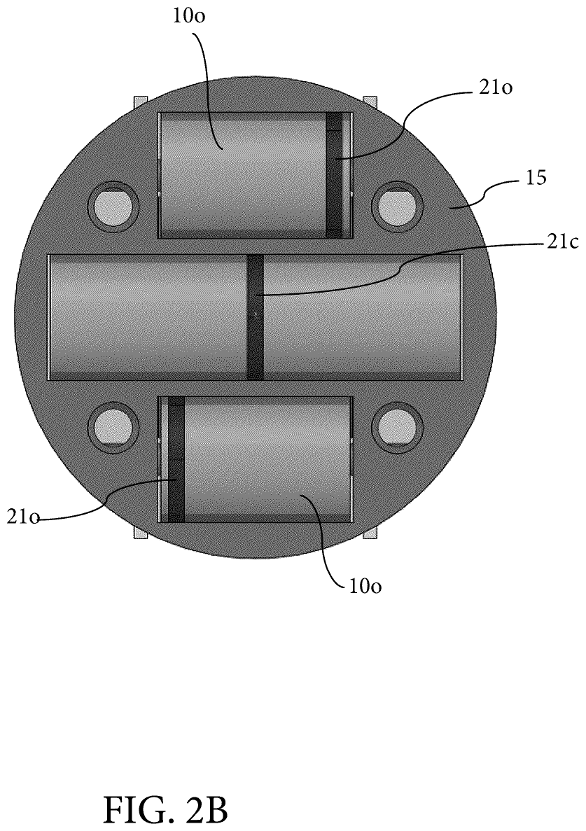

### Puck—Example Embodiment FIGS. 2A-2B

FIGS. 2A and 2B are a perspective illustration and a top view, respectively, of a puck including a poly drive according to an example embodiment. According to an implementation of example embodiments described herein, the puck 200 may include a plate 15 supporting a plurality of convey rollers 10, and a frame 15 supporting a driving motor 20. The plate 15, convey rollers 10, frame 15, and driving motor 20 may be analogous to those described with respect to the example embodiment of FIG. 1. Distinct from the example embodiment of FIG. 1, the puck 200 of this example embodiment includes a plurality of belts 21. As shown in FIG. 2A, the puck 200 may include a plurality of belts 21 corresponding to the plurality of convey rollers 10: a central belt 21c around a roller 22 of the driving motor 20 and the central convey roller 10c; and a pair of outer belts 21o, respectively secured around the roller 22 of the driving motor 20 and the respective ones of the pair of outer rollers 10o. One or more additional belts may be secured around the roller 22 of the driving motor 20 and any one of the convey rollers 10, as would be understood by one of skill in the art. The central belt 21c is shown as secured around a central region of the roller 22 and a central region of the central convey roller 10c, and the outer belts 21o are shown as secured around opposite ends of the roller 22 and opposite ends of the pair of outer convey rollers 10o; however, this is merely an example arrangement, and the belts 21o may be secured to the roller 22 and the convey rollers 10o in any of various arrangements and positions as would be understood by one of skill in the art.

As with the example embodiment of FIG. 1, the drive motor of the example embodiment of FIGS. 2A and 2B may be operationally coupled, via a wired or wireless connection, to a controller thus enabling the direction, speed (rpm), and power of the motor to be independently controlled, thereby enabling each of the speed (rpm), direction, and power of the one or more convey rollers of the puck to be independently controlled.

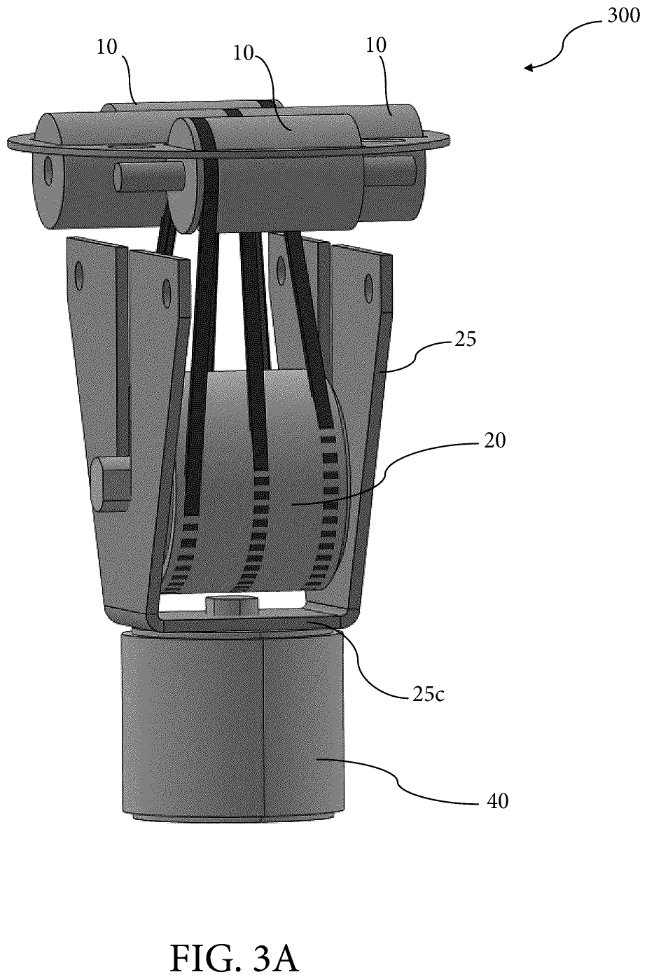

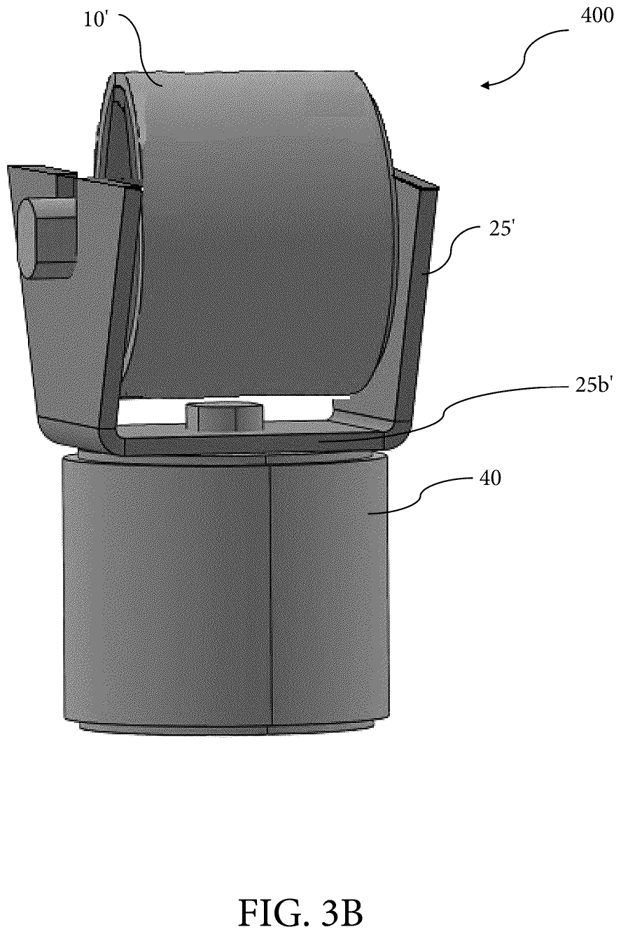

### Puck—Example Embodiments FIGS. 3A and 3B

FIG. 3A is a perspective illustration of an example puck including a swivel drive according to an example embodiment. According to an implementation of example embodiments described herein, the puck 300 may include a plate 15 and convey rollers 10 connected, via one or more belts 21 to a driving motor 20 held by a frame 25. The plate 5, convey rollers 10, one or more belts 21, driving motor 20, and frame 25 of the puck 300 of this example embodiment may be analogous or equivalent to those of the example examples embodiments of FIG. 1 or FIGS. 2A and 2B, or may be any of various other puck elements, as would be understood by one of skill in the art. According to this example embodiment, the puck 300 further includes a swivel motor 40. The swivel motor 40 is pivotably connected to the frame 25 and operates to control a pivot direction of the frame 25 around an axis AA normal to a surface S of the plate 15. As with the example motor rotors discussed with respect to the above embodiments, the swivel motor is connected to a power source and operationally connected to a controller (not shown) to thereby receive a signal enabling the swivel motor to be independently controllable. The swivel motor 40 may comprise a 24 Volt (V) direct current (DC) motor, or another motor as would be understood by one of skill in the art.

As with the example embodiments described above, the drive motor of the example embodiment of FIG. 3A may be operationally coupled, via a wired or wireless connection, to a controller thus enabling the direction, speed (rpm), and power of the motor to be independently controlled, thereby enabling each of the speed (rpm), direction, and power of the one or more convey rollers of the puck to be independently controlled. Likewise, the swivel motor may be operationally coupled, via a wired or wireless connection, to a controller thus enabling the direction, speed (rpm), and power of the motor to be independently controlled, thereby enabling each of the speed (rpm of rotation of the frame, e.g.), direction, and power of the rotation of the frame to be independently controlled.

FIG. 3B is a perspective illustration of another example puck including a swivel drive according to an example embodiment. According to an implementation of example embodiments described herein, the puck 400 may include a frame 25′ and a convey roller 10′ which is both a convey roller and a motor. The convey roller 10′ is rotatably supported by the frame 25, and may incorporate a motor functioning as a drive motor which directly drives rotation of the convey roller 10′. Thus, the convey roller 10′ may comprise a 24 Volt (V) direct current (DC) motor, or another motor as would be understood by one of skill in the art.

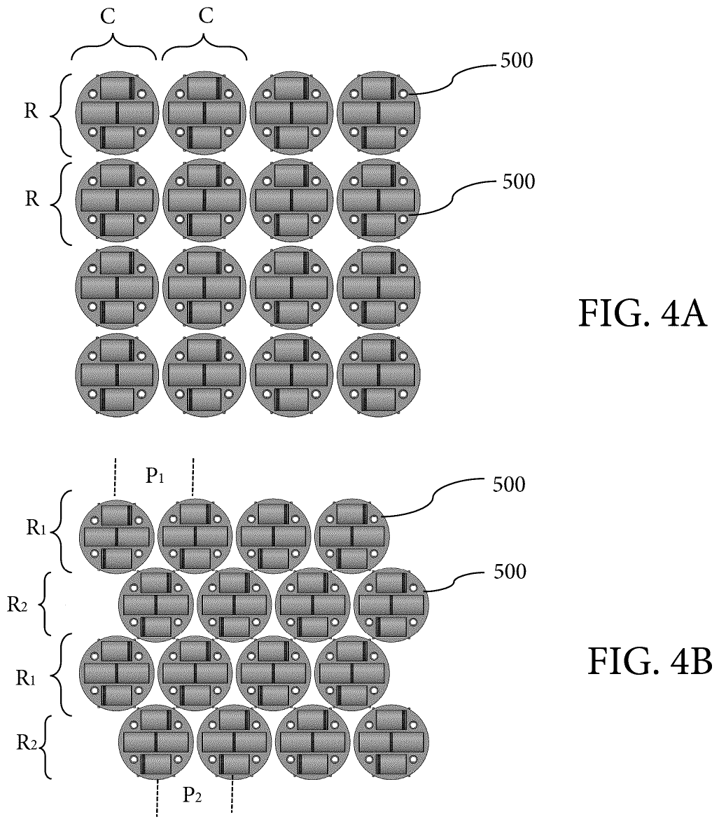

### Example Arrangements of Pucks—Example Embodiments FIGS. 4A-4C

FIGS. 4A and 4B illustrate different arrangements of a plurality of pucks according to example embodiments. According to an implementation of example embodiments described herein, the pucks 500 in these arrangements may be any of those 100, 200, or 300 described with respect to the example embodiments of FIGS. 1 and 2A-2C or may be modified from the examples of FIGS. 1 and 2A-2C. As shown in FIG. 4A, a plurality of pucks 500 may be disposed in a traditional layout comprising a plurality of rows R and columns C in which the pucks in each row R are aligned with the pucks in each other row R, thus forming aligned columns C. As shown in FIG. 4B, a plurality of pucks 500 may be disposed in a staggered layout comprising a first plurality of rows R₁, including pucks spaced by a pitch P₁, alternating with a plurality of second rows R₂, including pucks spaced by a pitch P₂. As shown in the example of FIG. 4B, the pitch P₁ may be the same as the pitch P₂, and the plurality of second rows R₂ are offset by ½ P, such that centers of the pucks of second, offset, rows R₂ are disposed midway between the centers of the pucks of the first rows R₁. The staggered layout of FIG. 4B allows the rows R to be nestled closer together than the rows of the traditional layout shown in FIG. 4A. The staggered layout of FIG. 4B is merely an example, and the pucks may be arranged in any of various other staggered layouts, as would be understood by one of skill in the art.

The dimensions of the pucks according to the example embodiments described with respect to any of FIGS. 1, 2A-2C, 3, 4A, and 4B may be determined by one of skill in the art. For example, each puck 100 or 200 may have an outer diameter of 4 inches (in.) or less, or an outer diameter of 3 in. or less, and in the example arrangements of FIGS. 4A and 4B, the pucks 100 or 200 may be spaced at a pitch of 4 in. by 4 in. in the traditional layout or a pitch of 4 in. by 3.5 in. in a staggered layout. As shown in the example arrangement of FIG. 4C.

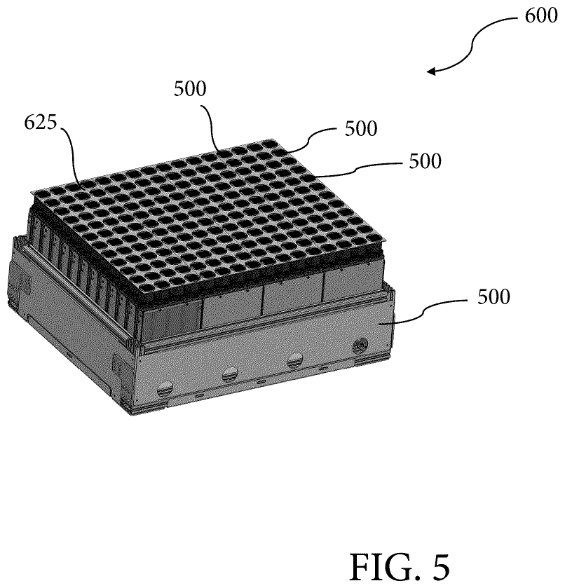

### Module—Example Embodiment FIG. 5

FIG. 5 is a perspective view of an addressable roller module 600 according to an example embodiment. According to an implementation of example embodiments described herein, and as shown in FIG. 5, a module 600 may include an array of a plurality of pucks 500, mounted within a module frame 625 also holding therewithin guarding and wiring (not shown). Each of the plurality of pucks 500 may be a puck according to one of the example embodiments described herein, or may be modified therefrom as would be understood by one of skill in the art. The pucks 500 in the module 600 may be arranged in one of a traditional layout or a staggered layout as described herein, or in another, modified layout, such as an irregular layout, as would be understood by one of skill in the art. According to this example embodiment, each puck 500 comprises at least one convey roller protruding from a top surface SS of the module 600 and rotatable about its axel which is held substantially parallel to the top surface SS. Each puck 500 also includes a drive motor which drives the at least one convey roller, and a swivel motor which drives a rotation (swivel) of the convey roller about a swivel axis normal to the top surface SS. Each of the drive motor and the swivel motor may be a 48 V DC motor, and each of the drive and swivel motors is independently addressable and controllable via a wired or wireless connection to a controller, as discussed above with respect to the example embodiments of FIGS. 1, 2A and 2B, and 3. Accordingly, each of the speed (rpm), direction, and power of each convey roller of each of the plurality of pucks 500 of the module 600 is independently controllable via the drive motor of the corresponding puck operationally connected to and independently controlled by a controller. Likewise, each of the speed (e.g. rpm of the rotation of the frame), direction, and power of the rotation of the frame of each of the plurality of pucks 500 and thus of the corresponding convey roller(s) thereof, of the module 600 is independently controllable via the swivel motor of the corresponding puck operationally connected to and independently controlled by a controller.

According to one or more example embodiments, in view of the independent addressability and controllability of each motor of each puck, a single convey roller can change speed and direction of conveyance and can rotate clockwise or counter clockwise, for example, through 90 degrees, 180 degrees, or even 360 degrees. The result is that a module can convey in any direction.

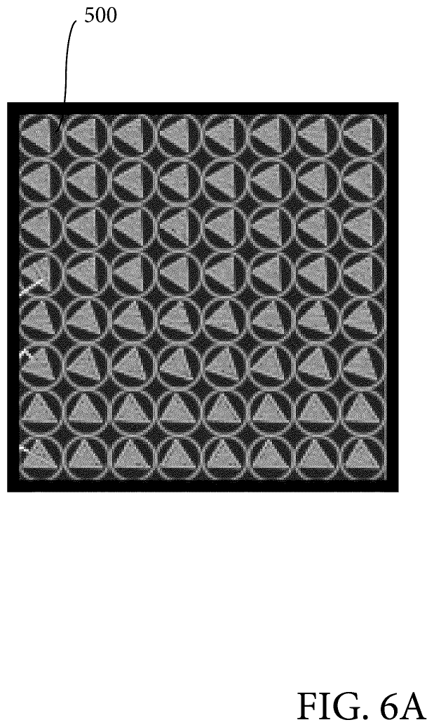

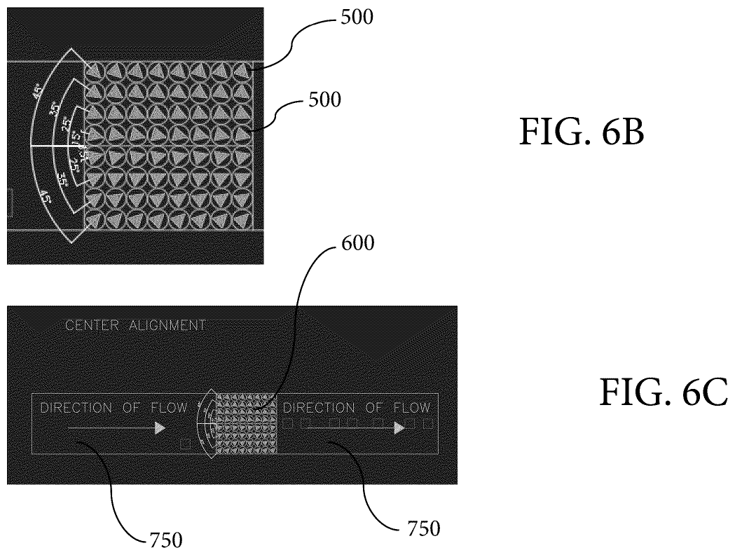

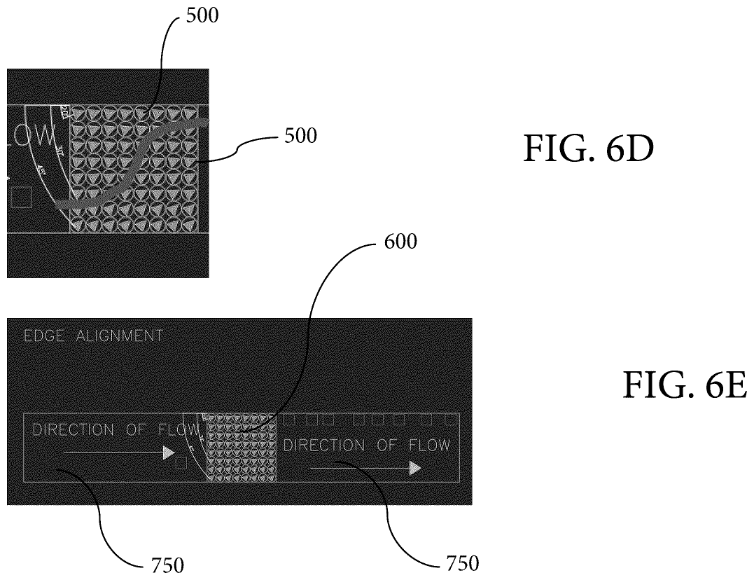

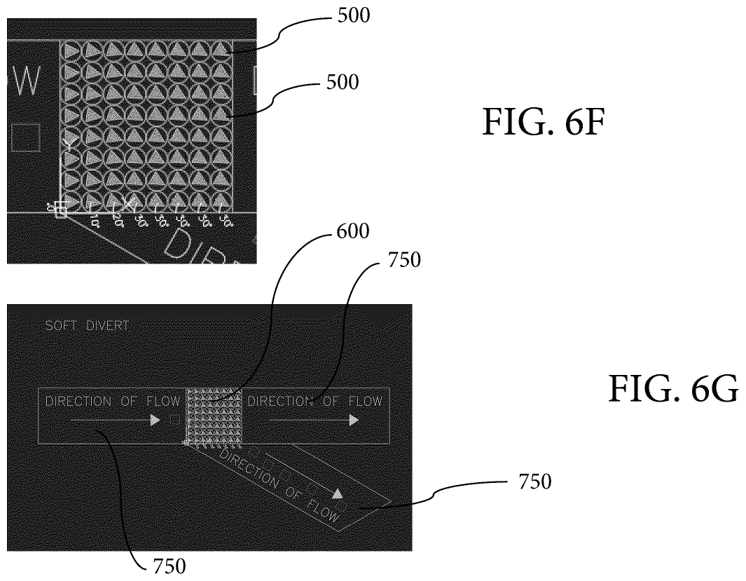

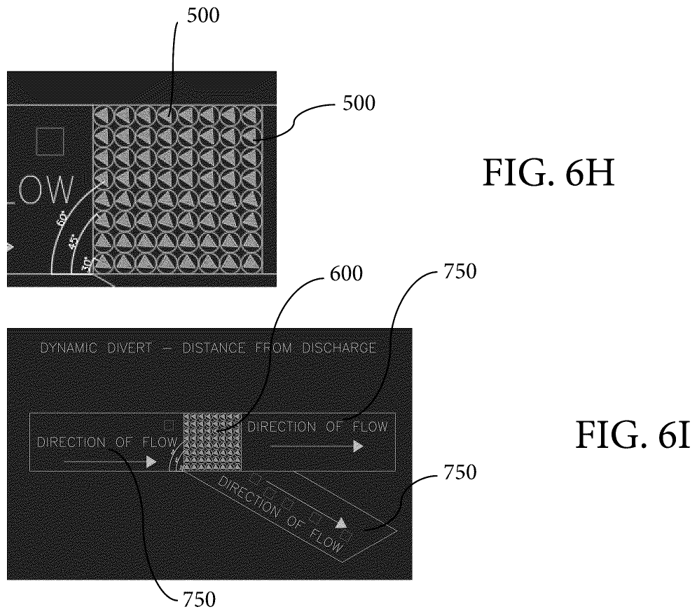

Due to the independent controllability of the speed, direction and power of both the convey roller and the swivel of the convey roller of each puck in an addressable roller module, the surface of a single addressable roller module or a surface formed by an array of a plurality of addressable roller modules may be controllable to convey one or more items on a dynamically changeable path. In other words, for example, the surface formed by the array may be controllable into a first configuration to convey one or more items, for example in a first direction or manner, and may then be controllable into a second configuration, different from the first configuration, to convey the same or different one or more items in a second, different, direction or manner. The field formed by an array of a plurality of pucks of one or more addressable roller modules will be referred to herein as a conveyance vector field, and, as described herein, the conveyance vector field may be changed among any of various different conveyance vector fields. FIG. 6A is a diagram of a conveyance vector field formed by one example addressable roller module 600 according to one or more example embodiments. As illustrated in FIG. 5, each puck 500 is shown with a representative arrow therein indicating the direction of flow resulting from the combination of the orientation (swivel) and the direction of rotation of the convey roller corresponding to the puck 500. FIGS. 6B-6I are schematic diagrams of various example vector fields, combinations of which may be used to guide items in any of various operations.

FIGS. 6B and 6C are schematic diagrams of an example conveyance vector field formed by an example addressable roller module, and of the example addressable roller module, disposed between two conveyor elements, and controlled to align conveyed items along a center of the flow path according to one or more example embodiments. As shown, this vector field may by formed by convey rollers aligned in more than two distinct directions, and the speed of each of multiple directional groupings of elements may be configured to yield the same resultant vector velocity in the conveyance direction.

FIGS. 6D and 6E are schematic diagrams of an example conveyance vector field formed by an example addressable roller module, and of the example addressable roller module, disposed between two conveyor elements, and controlled to align conveyed items along an edge of the flow path according to one or more example embodiments. As shown, this example vector field may include rollers aligned in more than one distinct direction, and the speed of each of multiple directional groupings of elements may be configured to yield a same resultant vector velocity in the conveyance direction.

FIGS. 6F and 6G are schematic diagrams of an example conveyance vector field formed by an example addressable roller module, and of the example addressable roller module, disposed between a first input conveyor element and two output conveyor elements, and controlled to “soft” divert a conveyed item onto a divert output conveyor element according to one or more example embodiments. Small parcels may slide, tumble, and/or lose their tracking when there are abrupt changes in speed or direction. If such parcels are identified prior to the divert, an addressable roller module can be controlled to “soft” divert such parcels by, for example, changing the speed and direction of each row of pucks from 0 degrees to 30 degrees, maintaining the vector speed in a pass through direction, and keeping the vector speed in the pass through direction at least substantially consistent with the conveyor speed when the convey rollers guide the parcels off of the pass through direction. As shown, this example vector field may be formed by convey rollers aligned in more than two distinct directions, and the speed of each of multiple directional groupings of elements may be configured to yield the same resultant vector velocity in the conveyance direction.

FIGS. 6H and 6I are schematic diagrams of an example conveyance vector field formed by an example addressable roller module, and of the example addressable roller module, disposed between a first input conveyor element and two output conveyor elements, and controlled to divert a conveyed item onto a divert output conveyor element according to one or more example embodiments. In a case in which parcels are not pre-aligned to a diverting side of a conveyor, an addressable roller module can increase a divert angle for parcels that are farther away from the discharge. In this example also, the vector speed may be maintained in the pass through direction at least substantially consistent with the conveyor speed. The divert angle may be based on parcel data obtained via a monitor system and a control system as discussed below. Longer parcels may require a more aggressive divert due to the resistance of the parcel that is on a conveyor element (e.g. an induct belt) while the leading edge of the parcel enters the addressable roller module. For example, a divert angle may be increased from 30 degrees to 45 degrees when the parcel length is greater than a length of the addressable roller module perpendicular to the direction of the flow. Wider parcels may require a more aggressive divert due to a limited clearance between the width of the parcel and the width direction of the conveyor element. The leading edge of a wider parcel may be turned more quickly to endure that the parcel makes it onto a discharge conveyor element without colliding with a side of the element, potentially causing jams. For example, a divert angle may be increased from 30 degrees to 45 degrees when the parcel width is greater than 50% of a width of the discharge conveyor element perpendicular to the direction of flow.

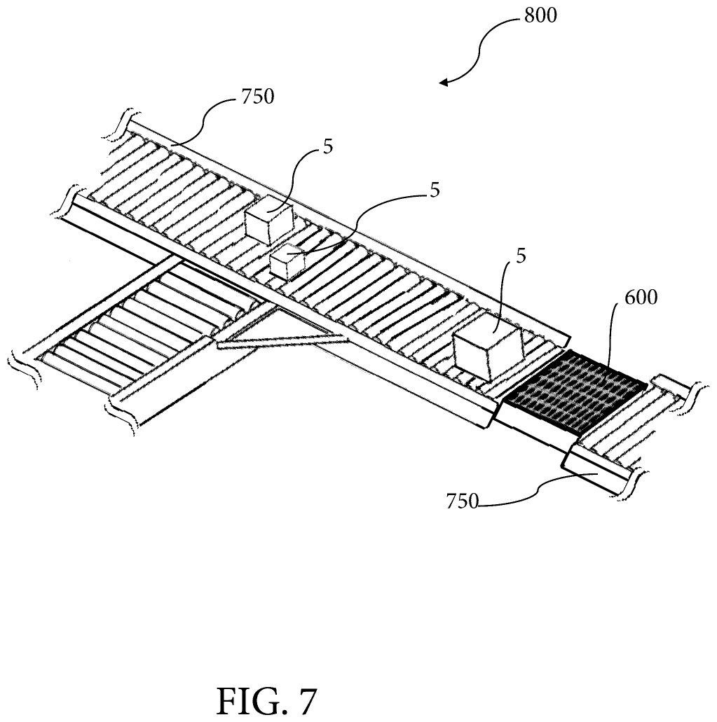

### Example Sortation System—Example Embodiment FIG. 7

FIG. 7 is a diagram of a sortation system including an addressable roller module according to an example embodiment. According to one or more example embodiments, a sortation system may include any of a variety of different types of conveyors, a plurality of which may be arranged together to form one or more paths for conveying items, where the paths may branch, turn, and/or merge. The system 800 of FIG. 7 includes an first conveyor element 750 which conveys items 5 onto an addressable roller module 600, which in turn, conveys items onto a second conveyor element 750.

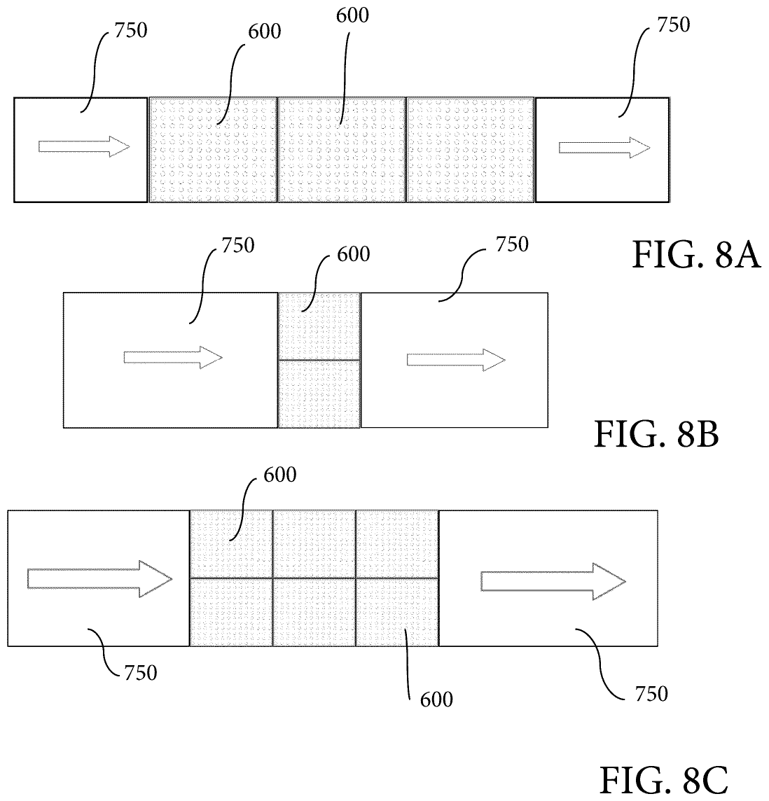

FIGS. 8A-8C are perspective illustrations of different arrangements of multiple addressable roller modules according to one or more example embodiments. FIG. 8A shows three addressable roller modules 600 aligned in a series and disposed between a first conveyor element 750 and a second conveyor element 750. The illustration of three modules in FIG. 8A is merely an example and more or fewer modules may be aligned in a series. FIG. 8B shows two addressable roller modules 600 aligned in parallel and disposed between a first conveyor element 750 and a second conveyor element 750. The illustration of two modules in FIG. 8A is merely an example and more modules may be aligned in a series. FIG. 8C shows an array of six addressable roller modules 600 disposed between a first conveyor 750 and a second conveyor 750. In each of FIGS. 8A-8C, the arrows on the first and second conveyor elements indicate the conveying direction, and in each of FIGS. 8A-8C, there is only a single (first) conveyor element which inputs items to the modules and only a single (second) conveyor element which receives items from the modules; however, these are merely examples, and two or more conveyor elements may input to an arrangement of modules and/or two or more conveyor elements may receive items output from an arrangement of modules.

Monitor system—According to one or more example embodiments, a sortation system may include a monitor system (not shown) configured to image and/or identify items being conveyed, the destination(s) of items, the location(s) of items within the sortation system, the arrangement and positioning of items on a conveyor or other element, and the desired path of items in the system. An example monitor system may include one or more: barcode readers positioned to read information, for example from barcodes attached to items, such as identification data, destination, and desired path of item(s); RFID readers positioned to receive information, for example from RFID tags attached to items or to trays, shoes, or other parts of a conveyor element, such as identification data, destination, and desired path of item(s); imaging devices positioned to image items at any of various points within the system and operationally connected to a processor or other device configured to determine, for example, locations, arrangements, sizes and shapes or item(s); processing element (PE) array(s) positioned to image items at any of various points within the system and operationally connected to a processor or other device configured to determine, for example, locations, arrangements, sizes and shapes or item(s). Photoelectric imaging devices, for example, may be used, in conjunction with a processor or other device to identify and track the leading and trailing edges of one or more items and/or the positions, sizes, and shapes of spacings (gaps) between and among items. One or more readers and/or imaging devices may be disposed at each divert location to ensure proper diverting.

Control system—According to one or more example embodiments, a sortation system may include a control system (not shown) configured to obtain information from the monitor system, and, based on the information, independently control each puck in each addressable roller module within the system. According to one or more example embodiments, a control system can be implemented, at least in part, in digital electronic circuitry, analog electronic circuitry, or in computer hardware, firmware, software, or a combination thereof. These components can be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or other device or on multiple device at one site or distributed across multiple sites and interconnected by a communication network. Also, functional programs, codes, and code segments for accomplishing features described herein can be easily developed by programmers skilled in the art. Operations associated with the example embodiments can be performed by one or more programmable processors executing a computer program, code or instructions to perform functions (e.g., by operating on input data and/or generating an output). Operations can also be performed by, and apparatuses described herein can be implemented as, special purpose logic circuitry, e.g., a field programmable gate array (FPGA) or an application-specific integrated circuit (ASIC), for example.

A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory (ROM) (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Computer-readable non-transitory media includes all types of computer readable media, including magnetic storage media, optical storage media, flash media and solid state storage media. It should be understood that software can be installed in and sold with a central processing unit (CPU) device. Alternately, software can be obtained and loaded into the CPU device, including obtaining the software through physical medium or distribution system, including, for example, from a server owned by the software creator or from a server not owned but used by the software creator. The software can be stored on a server for distribution over the Internet, for example.

The control system may be communicatively and operationally connected to the monitor system via wired or wireless connections either to the monitor system as a whole, or separately to individual elements or groups of elements of the monitor system. Wireless connections may be, for example, via antennas, Bluetooth or Bluetooth Low Energy (BLE), Near-Field Communication (NFC), or another means, as would be understood by one of skill in the art. The control system may also be communicatively and operationally connected to each addressable roller module within a sortation system, via wired or wireless connections either to multiple modules together, separately to each individual module, or separately to independent pucks or elements within a module. As with the connections to the monitor system, wireless connections to the module(s) may be, for example, via antennas, Bluetooth or Bluetooth Low Energy (BLE), Near-Field Communication (NFC), or another means, as would be understood by one of skill in the art.

### Example Operations

According to one or more example embodiments, one or more addressable roller modules may be positioned individually, in series, or in an array, between or among conveyors and other elements of a sortation system in order to perform any of a number of different or combined operations.

Singulation—Items in a sortation system may be conveyed in a bulk flow, or a non-organized type of flow in which, for example, a number of items are conveyed in no particular arrangement, not in consistent positions, orientations, and without any consistent pitch between items. Related art sortation technology cannot sort individual items when they are in a bulk flow. Singulation is a process by which items in a bulk flow are moved, shifted, and conveyed in such a manner as to position the items in a manner suitable for individual, automated sortation, such as in a single flow with a uniform pitch or gap. According to an example embodiment, one or more addressable roller module(s), such as, but not limited to, the example module 600, may be arranged individually, in series, or in an array, between conveyor elements in a system to receive a bulk flow of items from a preceding conveyor element, perform sortation thereby arranging the received items into a single flow, and direct the single flow onto a subsequent conveyor element. The module(s) may be controlled to form dynamically changing conveyance vector fields including, for example, those of FIGS. 6B, 6C, 6D, and 6E. Additionally, one module, or multiple modules in parallel may form multiple conveyance vector fields, each controlled to direct the flow of one of many smaller items.

Additionally, according to an example embodiment, the module(s) may be controlled in a “park and go” operation in which one or more items may be directed out of a singulated flow stream and injected back into the flow stream when a suitable window, or gap, is available.

Diversion—Diversion is a process by which the conveyance path of one or more items may be shifted (turned), as, for example, to direct an item from a first conveyor element conveying in a first direction onto another conveyor element conveying in a second, different direction. In another diversion example, an item may be directed from a conveyor element conveying in a first direction to an output. According to an example embodiment, one or more module(s), such as, but not limited to, the example module 600, may be controlled to form dynamically changing conveyance vector fields including, for example those of FIGS. 6F, 6G, 6H, and 6I.

Sortation—Sortation is a process by which items are shifted with respect to each other, for example, moving one or more items faster than other items, directing one or more items to be closer together or farther away from each other, and diverting different items in different directions. According to an example embodiment, one or more module(s), such as but not limited to, the example module 600, may be controlled to form dynamically changing conveyance fields including any of those described herein, and any others, as would be understood by one of skill in the art. Such sortation may be used to create or close a window between items or for controlled merging of items/flows.

Combinations—According to an example embodiment, as would be understood by one of skill in the art based on the descriptions herein, one or more module(s), such as, but not limited to, the example module 600, may be deployed as individual modules and/or rows, lines, or arrays of modules and may be combined with a monitor system and control system and related art conveyor elements and within a sortation system, thus enabling many different operations including bulk flow input, singulation, alignment, diversion, sortation, and any combinations of these operations.

Additional example implementations—According to one or more example embodiments, one or more monitor and control systems may be implemented in combination with one or more addressable roller modules such as but not limited to the example module 600, may operate together to track items through the sortation system, measure gaps between products, trigger sortation, trigger error operations, trigger safety operations, determine a distance between an item and a fixed point, modify or trigger operations for dynamic diverting, merging, and/or singulation, acquire item position, orientation, and velocity, and trigger or modify item manipulation operations

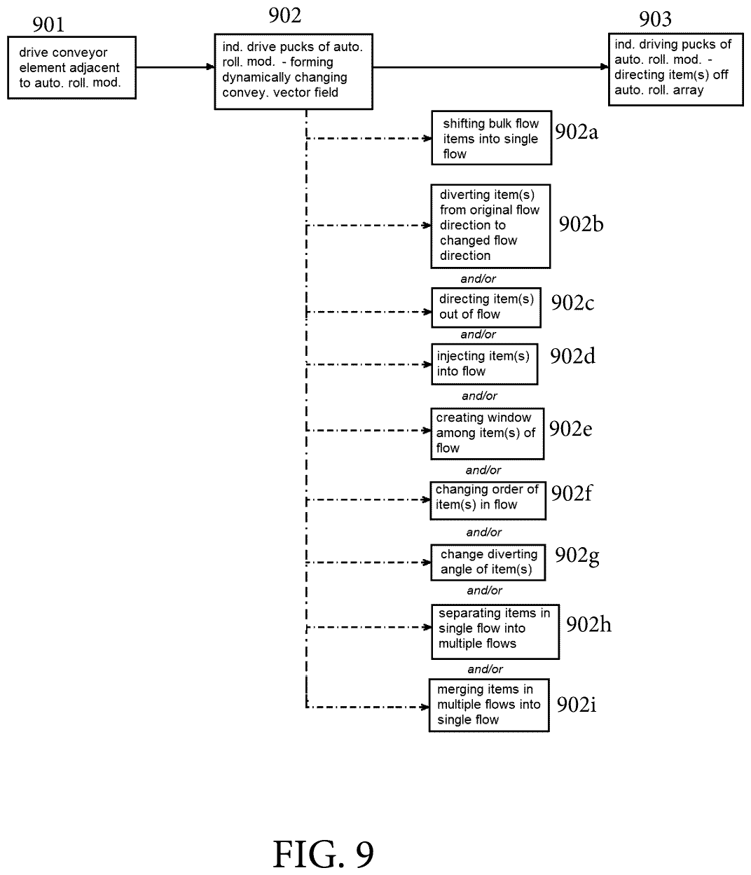

FIG. 9 illustrates a flow of example methods according to one or more example embodiments. According to one or more example embodiments, a method of controlling a sortation system may include: driving a first conveyor element positioned adjacent to an automated roller module, controlling the conveyor element to direct item(s) onto the automated roller module (901); independently driving each of a plurality of pucks of the automated roller module, thereby forming a dynamically changing conveyance vector field (902); and independently driving pucks of the automated roller module, thereby directing item(s) off the automated roller module (903). The operation 901 may be modified to another method of causing item(s) onto the automated roller module, such as, but not limited to, automatically dumping or placing items from a chute or other location onto the automated roller module. The independently driving each of a plurality of pucks of the automated roller module, thereby forming a dynamically changing conveyance vector field may include any of shifting bulk flow items into a single flow (902a); diverting item(s) from an original flow direction to a changed flow direction (902b); directing item(s) out of a flow (902c); injecting item(s) into a flow (902d); creating a window among item(s) of a flow (902e); changing an order or item(s) in a flow (902f); changing a diverting angle of item(s) (902g); separating items in a single flow into multiple flows (902h); and/or merging items in multiple flows into a single flow (902i). The independently driving each of the plurality of pucks of the automated roller module, thereby forming a dynamically changing conveyance vector field may alternately, additionally, and/or in combination, include any of various other operations of conveying, shifting, or otherwise moving item(s) in the sortation system. The method may further include an operation of receiving data from one or more elements of a monitor system according to one or more example embodiments as discussed herein, and the operations of the method may be performed by a sortation system including a control system as described herein according to one or more example embodiments.

While aspects and implementation of example embodiments have been shown and described herein, it will be understood by those skilled in the art that various changes in form and details may be made therein. For example, various communication protocols can be deployed with various electronic sensors, and/or various visual and/or audio user interfaces can be implemented to facilitate processing and/or displaying information and/or controlling hardware and/or software components of the system.

It may be understood that example embodiments described herein may be considered in a descriptive sense only and not for purposes of limitation. Descriptions of features, aspects, or implementations within each example embodiment may be considered as available for other similar features, aspects, or implementations in other example embodiments.

Furthermore, example embodiments described herein may be implemented in conjunction with any of various individual components and methodologies, as well as any of various combinations of components and methodologies described, for example, in any of: U.S. Pat. No. 11,731,169; U.S. Published Patent Application Pub. No. 2023-0159281; and/or U.S. patent application Ser. No. 18/419,410, filed Jan. 22, 2024. The disclosures of U.S. Pat. No. 11,731,169; U.S. Published Patent Application Pub. No. 2023-0159281; and/or U.S. patent application Ser. No. 18/419,410, are incorporated herein by reference in their entireties.

While example embodiments have been and described with reference to the figures, it will be understood by those skilled in the art that various changes in form and details may be made therein without departing from the spirit and scope as defined by the following claims.

We claim:

1. An automated roller module comprising:
a module frame; and
an array of a plurality of pucks attached to the module frame, each of the plurality of pucks comprising:
a support frame,
a roller/driving motor combination comprising a convey roller rotatably connected to the support frame and rotatable about a driving axis parallel to an upper plane, and a driving motor connected to the support frame and operatively connected to the convey roller and configured to drive rotation of the convey roller, and
a swivel motor connected to the module frame and rotatably connected to the support frame and configured to drive a rotation of the support frame with respect to the module frame about a swivel axis normal to the upper plane.

2. The automated roller module of claim 1, further comprising:
a controller operatively and independently coupled to the driving motor of each of the plurality of pucks and operatively and independently coupled to the swivel motor of each of the plurality of pucks;
wherein the controller comprises a memory storing instructions and a processor configured to execute the instructions and thereby independently control a rotational speed and a direction of the convey roller of each of the plurality of pucks about the driving axis and independently control a rotation of the convey roller of each of the plurality of pucks about the corresponding swivel axis.

3. The automated roller module of claim 2,
wherein the control module is configured to dynamically control the swivel motors of the plurality of pucks to form at least a first conveyance vector field and a second conveyance vector field different from the first conveyance vector field.

5. The automated roller module of claim 1, wherein:
the module frame comprises a top plate; and
each of the plurality of pucks is attached to the module frame such that the convey roller of each of the plurality of pucks protrudes above the top plate and extends below the top plate, such that the rotation of the support frame with respect to the module frame comprises rotation of the convey roller with respect to the top plate about the swivel axis.

6. A sortation system comprising:
at least one automated roller module comprising: a module frame; and an array of a plurality of pucks attached to the module frame, each of the plurality of pucks comprising:
a support frame,
a roller/driving motor combination comprising a convey roller rotatably connected to the support frame and rotatable about a driving axis parallel to an upper plane, and a driving motor connected to the support frame and operatively connected to the convey roller and configured to drive rotation of the convey roller, and
a swivel motor connected to the module frame and rotatably connected to the support frame and configured to drive a rotation of the support frame with respect to the module frame about a swivel axis normal to the upper plane; and
a control module operatively and independently coupled to the driving motor of each of the plurality of pucks and operatively and independently coupled to the swivel motor of each of the plurality of pucks.

7. The sortation system of claim 6, further comprising:
an input conveyor element disposed adjacent to the at least one automated roller module; and
an output conveyor element disposed adjacent to the at least one automated roller module;
wherein the control module is operatively coupled to each of the input conveyor element and the output conveyor element and is configured to drive the input conveyor element to direct one or more items onto the at least one automated roller module.

8. The sortation system of claim 7, wherein the control module comprises a memory storing instructions and a processor configured to execute the instructions and thereby independently control a rotational speed and a direction of the convey roller of each of the plurality of pucks about the driving axis and independently control a rotation of the convey roller of each of the plurality of pucks about the corresponding swivel axis.

9. The sortation system of claim 8,
wherein the control module is configured to dynamically control the swivel motors of the plurality of pucks to form at least a first conveyance vector field and a second conveyance vector field different from the first conveyance vector field.

10. The sortation system of claim 8, further comprising:
a monitor system communicatively coupled to the control module, the monitor system comprising at least one sensing element positioned and configured to obtain data of one or more items in the sortation system and transmit the data to the control module;
wherein the processor of the control module is further configured to control the driving motor and the swivel motor of each of the plurality of pucks based on the data from the monitor system.

11. The sortation system of claim 6, wherein the at least one automated roller module comprises an array of plurality of automated roller modules.

12. The sortation system of claim 7,
wherein the output conveyor element comprises a first output conveyor element and a second output conveyor element; and
wherein the control module is configured to dynamically control the swivel motors of the plurality of pucks to form a dynamic conveyance vector field such that at least a first item of the one or more items is conveyed onto the first output conveyor element and at least a second item of the one or more items is diverted onto the second output conveyor element.

13. An automated sortation method of a sortation system comprising a plurality of conveyor elements, at least one automated roller module comprising an array of a plurality of pucks, each of the plurality of pucks comprising a convey roller rotatable about a driving axis in an upper plane and a swivel motor configured to rotate the driven motor in the upper plane about a swivel axis normal to the upper plane; the method comprising:
controlling an input conveyor element of the plurality of conveyor elements to thereby deposit one or more items onto the automated roller module;
controlling the automated roller module to form a first conveyance vector field by:
independently driving the convey roller of each of the plurality of pucks, and
independently driving the swivel motor of each of the plurality of pucks; and
controlling the automated roller module to form a second conveyance vector field, different from the first conveyance vector field by:
independently driving the convey roller of each of the plurality of pucks, and
independently driving the swivel motor of each of the plurality of pucks.

14. The method according to claim 13, further comprising:
at least one sensing element of the sortation system obtaining data of the one or more items; and
performing the controlling the automated roller module to form a first conveyance vector field and the controlling the automated roller module to form a second conveyance vector field based on the data of the one or more items.

15. The method according to claim 13, wherein:
the controlling the automated roller module to form a first conveyance vector field and the controlling the automated roller module to form a second conveyance vector field comprises controlling the automated roller module to form a dynamically changing conveyance vector field, thereby shifting a plurality of items from a non-organized flow into a single flow of the plurality of items and outputting the plurality of items onto at least one output conveyor element of the plurality of conveyor elements.

16. The method according to claim 13, wherein:
the one or more items comprise a plurality of items; and
the controlling the automated roller module to form a first conveyance vector field and the controlling the automated roller module to form a second conveyance vector field comprises controlling the automated roller module to form a dynamically changing conveyance vector field, thereby changing a spacing among one or more of the plurality of items.

17. The method according to claim 13, wherein:
the one or more items comprise a plurality of items; and
the controlling the automated roller module to form a first conveyance vector field and the controlling the automated roller module to form a second conveyance vector field comprises controlling the automated roller module to form a dynamically changing conveyance vector field, thereby performing at least one of:
diverting an item of the plurality of items out of a flow of items,
introducing an item of the plurality of items into a flow of items,
changing an order of the plurality of items,
changing a position of at least one first item relative to a position of at least one second item, and
rotating at least one item.

18. The method according to claim 13, wherein:
the one or more items comprise a plurality of items;
the plurality of conveyor elements further comprises a first output conveyor element and a second output conveyor element; and
the controlling the automated roller module to form a first conveyance vector field and the controlling the automated roller module to form a second conveyance vector field comprises controlling the automated roller module to form a dynamically changing conveyance vector field, thereby:
directing a first item of the plurality of items onto the first output conveyor element and directing a second item of the plurality of items onto the second output conveyor element.

19. The method according to claim 13, wherein:
the input conveyor element comprises a first input conveyor element and a second input conveyor element;
the one or more items comprise a plurality of items; and
the controlling the automated roller module to form a first conveyance vector field and the controlling the automated roller module to form a second conveyance vector field comprises controlling the automated roller module to form a dynamically changing conveyance vector field, thereby
merging at least one item of the plurality of items conveyed by the first input conveyor and at least one item of the plurality of items conveyed by the second input conveyor into a single flow of a plurality of items and outputting the single flow of the plurality of items onto an output conveyor element.

20. The method according to claim 13, wherein:
the at least one automated roller module comprises an array of a plurality of automated roller modules; and
the controlling the automated roller module to form a first conveyance vector field and the controlling the automated roller module to form a second conveyance vector field comprises independently driving the convey roller of each or the plurality of pucks of each of the plurality of automated roller modules and independently driving the swivel motor of each of the plurality of pucks of each of the plurality of automated roller modules.

21. The sortation system of claim 6, wherein the convey roller and the driving motor, of the roller/driving motor combination, are integrally formed.
